(19) United States
(12) Patent Application Publication
(10) Pub. No.: US 2006/0133287 A1
(43) Pub. Date: Jun. 22, 2006

(54) Frame forwarding device and method for staying loop of frame

(76) Inventor: Tetsuya Nishi, Kawasaki (JP)

Correspondence Address: SWIDLER BERLIN LLP, 3000 K STREET, NW, BOX IP, WASHINGTON, DC, 20007, US

(21) Appl. No.: 11/106,591

(22) Filed: Apr. 15, 2005

(30) Foreign Application Priority Data
Dec. 20, 2004 (JP) JP2004-367881

(51) Int. Cl. H04J 3/14; H04L 12/28

(52) U.S. Cl. 370/251; 370/351

(57) ABSTRACT

A frame forwarding device for forwarding a frame in a network of a datalink layer includes: an acquisition unit for acquiring a status of an adjacent port from an adjacent device having the adjacent port accommodating a link accommodated in a port of a self-device; a determination unit for determining whether or not a frame loop is generated based on an inconsistency between a status of the port of the self-device and the status of the adjacent port; and a blocking unit for blocking the port of the self-device when determined that the loop is generated.

### BACKGROUND OF THE INVENTION

The present invention relates to a frame forwarding device for forwarding a frame of Layer 2 (datalink layer of an OSI reference model).

Recently, a large-scale layer 2 network using an IEEE (Institute of Electrical and Electronic Engineers) 802.3 (Ethernet (Registered Trademark)) is configured. In a layer 2 network formed in a loop shape, as one control procedure for preventing data (frame) from circulating permanently on the loop, there is proposed a spanning tree protocol (STP). The STP is standardized as the IEEE 802.1d.

In the STP, control information called a BPDU (Bridge Protocol Data Unit) is exchanged between switches based on a given priority order. One path is set so as to be used usually, and the other paths are set as detour paths used at a time of failure occurrence.

As the prior art related to the present invention, for example, there is a technique described in the following Patent document 1.

[Patent document 1] JP 2002-101125 A

When the control based on the STP is operated normally, the permanent loop of data is prevented. However, when a failure occurs in the control based on the STP, there is a fear of causing the data loop.

Herein, in an IP (Internet Protocol) packet of Layer 3, a TTL (Time to Live) is set in the packet, and when the TTL value becomes 0, the packet is discarded. This prevents the generation of a loop.

However, in a frame used in the Ethernet, there is no configuration like the TTL. Thus, there is no means for staying a loop of data when the STP does not function normally.

### SUMMARY OF THE INVENTION

An object of the present invention is to provide a technique capable of efficiently staying a loop generated in a layer 2 network.

The present invention adopts the following configuration in order to solve the above-mentioned problems.

That is, the present invention provides a frame forwarding device for forwarding a frame in a network of a datalink layer, including:

an acquisition unit acquiring a status of an adjacent port from an adjacent device having the adjacent port accommodating a link accommodated in a port of a self-device;

a determination unit determining whether or not a frame loop is generated based on an inconsistency between a status of the port of the self-device and the status of the adjacent port; and

a blocking unit blocking the port of the self-device when determined that the loop is generated.

According to the present invention, the status of an adjacent port is acquired, and compared with the status of the port of the self-device. At this time, it is determined whether or not there is an inconsistency between both the statuses. When there is an inconsistency between them, it is determined that a loop is generated. In this case, the port of the self-device is blocked. This suppresses a frame loop.

Preferably, the determination unit in the present invention determines that the loop is generated when both the status of the port of the self-device and the status of the adjacent port represent forwarding of a frame, or when the status of the adjacent port to be compared with the status of the port of the self-device cannot be acquired from the adjacent device.

In such a case, a frame loop is highly likely to be generated. Therefore, by blocking the port at this time, a loop can be stayed from being generated.

Preferably, the determination unit in the present invention further determines that the loop is generated when there is a frame input from the adjacent device to the self-device. The loop is generated when a frame can be forwarded between the self-device and the adjacent device. Herein, when a frame does not flow on the link due to a link failure, a loop is not generated. Thus, a port is blocked only when there is actually a frame input. With this configuration, the generation of a loop can be determined strictly, and undesired port blocking can be stayed.

Preferably, the acquisition unit in the present invention periodically receives the request packet for inquiring about (regarding) the status of the port of the self-device from the adjacent device, returns a response packet including a status of a corresponding port with respect to each request packet, and when the request packet does not arrive any more, transmits the request packet for inquiring about the status of the adjacent port corresponding to the port of the self-device to the adjacent device.

Also, the present invention provides a method for staying a frame loop, including:

acquiring a status of an adjacent port from an adjacent device having the adjacent port accommodating a link accommodated in a port of a self-device in a network in which a frame of a datalink layer is forwarded;

determining whether or not a frame loop is generated based on an inconsistency between a status of the port of the self-device and the status of the adjacent port; and

blocking the port of the self-device when determined that the loop is generated.

According to the present invention, a frame loop generated in a layer 2 network can be stayed efficiently.

### BRIEF DESCRIPTION OF THE DRAWINGS

FIG. 1 is a diagram illustrating an example of a configuration of a frame forwarding device (layer 2 switch) in an embodiment of the present invention;

FIG. 2 is a diagram illustrating Operation Example 1 of the embodiment (during a normal state);

FIG. 3 is a diagram illustrating Operation Example 1 of the embodiment (at a time of failure occurrence);

FIG. 4 is a diagram illustrating Operation Example 2 of the embodiment (at a time of failure occurrence);

FIG. 5 is a diagram illustrating Operation Example 3 of the embodiment (during a normal state);

FIG. 6 is a diagram illustrating Operation Example 3 of the embodiment (at a time of failure occurrence);

FIG. 7 is a flow chart showing processing of the layer 2 switch according to Operation Examples 1 and 2; and

FIG. 8 is a flow chart showing processing of the layer 2 switch according to Operation Example 3.

### DETAILED DESCRIPTION OF THE PREFERRED EMBODIMENT

Hereinafter, the present invention will be described with reference to the drawings. The following configuration is described only for an illustrative purpose, and the present invention is not limited to the configuration.

<Configuration of Layer 2 Switch>

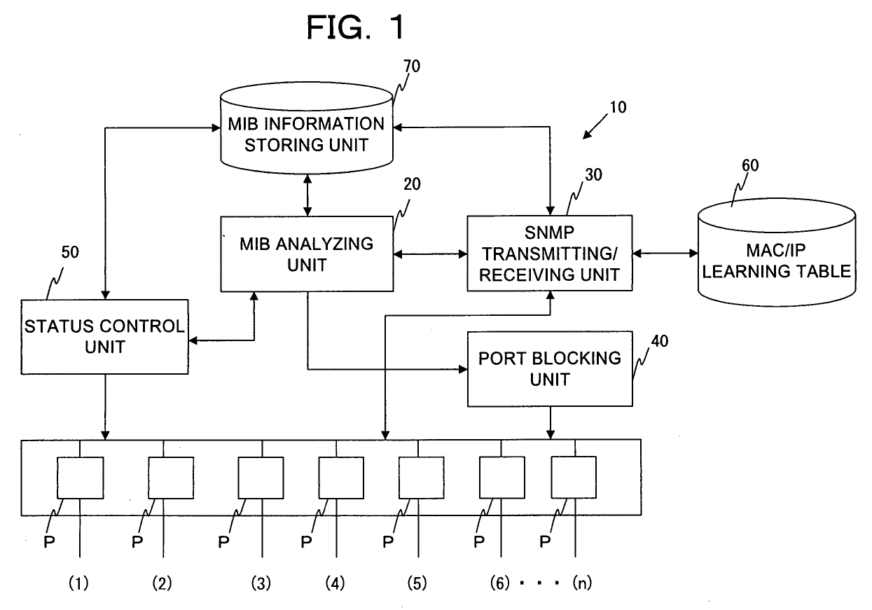

FIG. 1 is a block diagram showing a configuration example of a layer 2 switch realizing a frame forwarding device according to the present invention. In the present invention, the frame forwarding device is applied to a device performing frame forwarding by Layer 2 such as a layer 2 switch, a HUB, a bridge, or the like.

In FIG. 1, a layer 2 switch 10 includes n (n is a natural number) transmitting/receiving ports P, a MIB (Management Information Base) analyzing unit 20, an SNMP (Simple Network Management Protocol) transmitting/receiving unit 30, a port blocking unit 40, a status control unit 50, a MAC (Media Access Control)/IP learning table 60, and an MIB information storing unit 70.

The MIB analyzing unit 20, the SNMP transmitting/receiving unit 30, the port blocking unit 40, and the status control unit 50 are functions realized when a processor (e.g., a CPU) provided in the layer 2 switch 10 executes a program stored in a storage device. These respective units can be realized by hardware. The MIB information storing unit 70 and the MAC/IP learning table 60 are created on the storage device (e.g., a memory) provided in the layer 2 switch 10.

The MIB analyzing unit 20 functions as an analyzing unit and a determining unit. The SNMP transmitting/receiving unit functions as an acquisition unit of the present invention. The port blocking unit functions as a blocking unit of the present invention.

The status control unit 50 controls a status of a port P accommodating a link connecting a self-switch (layer 2 switch itself) to an adjacent switch in according with STP. In the STP, each switch receives control information called BPDU periodically (e.g., every 2 seconds) from a switch on an upstream side with respect to the flow of a frame, and the status of the port P is accordingly set. The status control unit 50 sets the status of each port in either of “Root,” “Forwarding,” and “Blocking” in accordance with the STP. This prevents a loop of data (frame) from being generated in a network. Furthermore, the status control unit 50 stores the set status of each port P in the MIB information storing unit 70.

The MIB analyzing unit 20 analyzes the status of each port (port status) of the self-switch based on the MIB information stored in the MIB information storing unit 70. At this time, if there is a port P with a status of “Root” or “Blocking,” the MIB analyzing unit 20 instructs the SNMP transmitting/receiving unit 30 to transmit an SNMP Request packet (corresponding to a request packet) for requesting the provision of the MIB information regarding the port status of a correspondence port (also written as “adjacent port”) to the adjacent switch regarding the port P.

When the SNMP request is given to the adjacent switch, the adjacent switch generates an SNMP Response packet (corresponding to a response packet) containing the MIB information regarding a status of an adjacent port, based on the SNMP request, and returns it. The MIB information included in the SNMP response is stored in the MIB information storage unit 70.

Furthermore, the MIB analyzing unit 20 refers to the MIB information storing unit 70 at a predetermined timing, and acquires the port status of the self-switch and the status of an adjacent port from the MIB information storing unit 70. When the acquired port status of the self-switch is “Forwarding,” and the port status of the adjacent switch is “Forwarding” or “no response,” the MIB analyzing unit 20 determines whether or not there is a traffic input from the port P. Then, when there is a traffic input, the MIB analyzing unit 20 instructs the blocking (link-down) of the port with respect to the port blocking unit 40.

The MIB analyzing unit 20 can be configured in such a manner that, when the port status of the self-switch changes from “Root” or “Blocking” to “Forwarding” (e.g., receives a status change notification from the status control unit 50), the MIB analyzing unit 20 refers to the MIB information storing unit 70 to acquire the status of a self-port and the status of an adjacent port and compares them. Alternatively, the MIB analyzing unit 20 can be configured in such a manner that, every time an SNMP response arrives (port status information of an adjacent port on the MIB information storing unit 70 is updated), the MIB analyzing unit 20 acquires the status of a self-port and the status of an adjacent port and compares them.

The SNMP transmitting/receiving unit 30 is instructed by the MIB analyzing unit 20 to acquire MIB information on the status of an adjacent port corresponding to a port P having the status of “Root” or “Blocking”. The SNMP transmitting/receiving unit 30 generates an SNMP packet including an SNMP request in accordance with the instruction, and transmits the SNMP packet to the adjacent switch.

The SNMP transmitting/receiving unit 30 can be configured so as to transmit an SNMP request to the adjacent switch periodically. In addition, the SNMP transmitting/receiving unit 30 can also be configured so as to transmit an SNMP request with the case where the port status of the self-switch is shifted from “Root” or “Blocking” (certain status) to “Forwarding” (predetermined status) as a trigger.

Furthermore, the SNMP transmitting/receiving unit 30 monitors the arrival of an SNMP response transmitted from the adjacent switch. The SNMP transmitting/receiving unit 30 has a monitoring timer for monitoring the arrival of an SNMP response, and when the SNMP response arrives before the monitoring timer reaches time-out, stores MIB information (including the status of an adjacent port) included in the SNMP response in the MIB information storing unit 70.

On the other hand, when the monitoring timer reaches time-out without the arrival of the SNMP response (when the status of an adjacent port cannot be acquired), the information showing “no response” is stored in the MIB information storing unit 70 as MIB information showing the port status of the adjacent port. The MIB information regarding the port status in the MIB information storing unit 70 is referred to and analyzed by the MIB analyzing unit 20.

On the other hand, when an SNMP request packet arrives from the adjacent switch, the SNMP transmitting/receiving unit 30 acquires MIB information on the status of a corresponding port P from the MIB information storing unit 70 in accordance with the SNMP request, and generates an SNMP response packet including the MIB information and returns it to the adjacent switch.

In the SNMP packet transmitted/received between the self-switch and the adjacent switch, information representing “high priority” can be set. With this configuration, the SNMP packet is transmitted/received preferentially and the processing related to this is performed even during the congestion of a network. More specifically, even when the load of a switch is increased due to the generation of a loop, the processing for staying a loop can be performed preferentially.

In the case of transmitting an SNMP packet, the SNMP transmitting/receiving unit 30 necessarily knows an IP address of the adjacent switch that is to receive the SNMP packet. The SNMP transmitting/receiving unit 30 performs the subsequent processing when the IP address of the adjacent switch is not known. More specifically, the SNMP transmitting/receiving unit 30 generates and transmits an ARP (Address Resolution Protocol) inquiry packet (ARP request) in which a certain host address in a subnet (subnet address is previously known) connected to the self-switch is set as the IP address of a communication partner (correspondent node) Thereafter, the SNMP transmitting/receiving unit 30 receives an ARP response packet with respect to the ARP request, compares (matches or checks) the MAC address of a search destination included in each ARP response with the MAC address (stored in the MIB information storing unit 70 as a part of MIB information) of the adjacent switch, and when the MAC addresses are the same, specifies the IP address of a communication partner included in the ARP response as the IP address of the adjacent switch.

The SNMP transmitting/receiving unit 30 changes the IP address of a communication partner of the ARP request and repeats transmitting the ARP request until the ARP response including the same MAC address as the MAC address of the adjacent switch is acquired. Alternatively, the SNMP transmitting/receiving unit 30 may generate and transmit a plurality of ARP requests in which all the host addresses (it is preferable that the IP address of the self-switch is excluded) in a subnet are respectively set as the IP addresses of communication partners, and may match (check) the MAC address of a search destination included in the ARP response corresponding to each ARP request with the MAC address of the adjacent switch to acquire the IP address of the adjacent switch.

Then, the SNMP transmitting/receiving unit 30 registers the correspondence relationship between the MAC address and the IP address of the adjacent switch in the MAC/IP learning table 60. Furthermore, in the case of receiving an SNMP packet from the adjacent switch, the SNMP transmitting/receiving unit 30 registers the IP address and the MAC address of a transmission source in the MAC/IP learning table 60. The SNMP transmitting/receiving unit 30 can generate an SNMP packet to be transmitted to the adjacent switch, using the MAC address and the IP address registered in the MAC/IP learning table 60.

The SNMP transmitting/receiving unit 30 can acquire the address of the corresponding adjacent switch from the MAC/IP learning table 60, and generate an SNMP request and transmit it to the adjacent switch. The port blocking unit 40 blocks the designated port (sets the designated port in link-down) in accordance with the instruction from the MIB analyzing unit 20. This can prevent or eliminate a data loop.

The MAC/IP learning table 60 associates the correspondence relationship between the MAC address and the IP address of the adjacent switch with the port P, and stores it. The processing of writing/reading with respect to the table 60 is performed by the SNMP transmitting/receiving unit 30.

The MIB information storing unit 70 stores MIB information on the port status acquired by transmission/reception of an SNMP packet. Furthermore, the MIB information storing unit 70 stores the status of each port P (port status) of the self-switch set by the status control unit 50. The contents stored in the MIB information storing unit 70 is referred to by the MIB analyzing unit 20 and the SNMP transmitting/receiving unit 30.

### OPERATION EXAMPLE 1

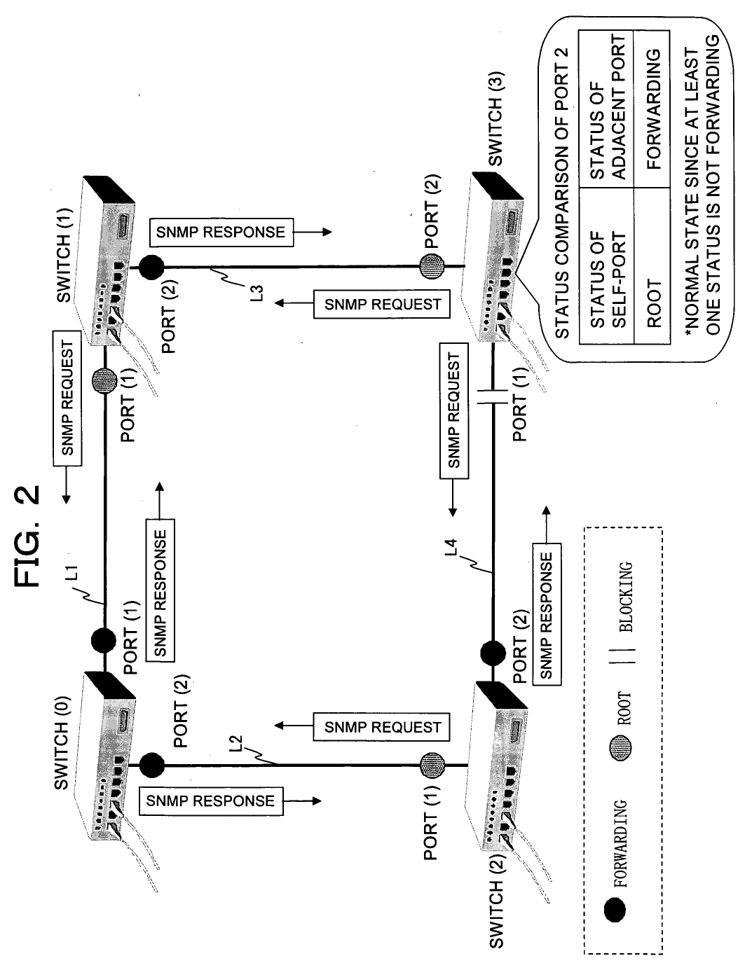

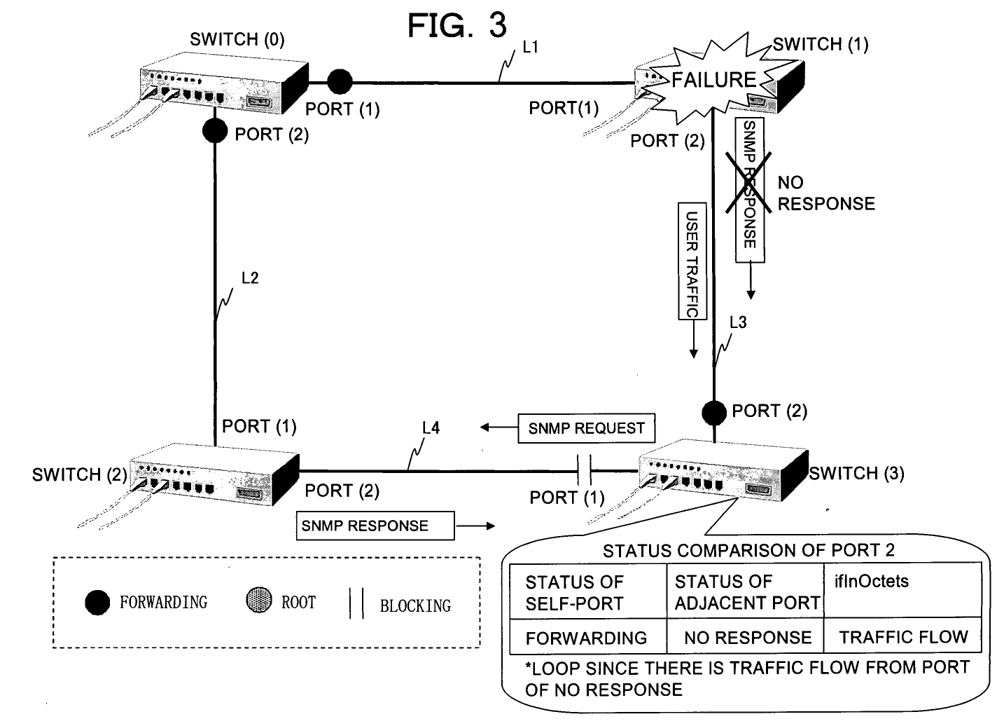

Next, an operation example in a network to which the layer 2 switch shown in FIG. 1 is applied will be described. FIGS. 2 and 3 are views illustrating Operation Example 1. FIG. 2 shows the operation of each of layer 2 switches when a failure does not occur in each of the layer 2 switches and the link connecting the switches (normal state). FIG. 3 shows the operation when a failure occurs in one layer 2 switch.

FIG. 2 shows the layer 2 network (Ethernet (Registered Trademark)) based on the IEEE (Institute of Electrical and Electronic Engineers) 802.3 in which switches (0), (1), (2), and (3) are connected. Each of the switches (0) to (3) has a configuration of the layer 2 switch shown in FIG. 1. The switch (0) is connected to the switches (1) and (2) via links L1 and L2. Furthermore, the switch (1) is connected to the switch (3) via the link L3, and the switch (3) is connected to the switch (2) via the link L4.

Each of the switches (0) and (1) respectively contains a link L1 at a port (1). Furthermore, the switch (0) contains a link L2 at a port (2), and the switch (2) contains a link L2 at a port (1). Furthermore, the switch (1) contains a link L3 at the port (2), and the switch (3) contains a link L3 at the port (2). The switch (2) contains a link L4 at the port (2), and the switch (3) contains a link L4 at the port (1).

Each of the switches (0) to (3) (the status control unit 50 thereof) sets the status of the respective ports (1) and (2) of the self-switch (port status) in accordance with the STP as follows. More specifically, the respective ports (1) and (2) of the switch (0) are respectively set in “Forwarding.” In the switch (1), the port (1) is set in “Root,” and the port (2) is set in “Forwarding.” In the switch (2), the port (1) is set in “Root,” and the port (2) is set in “Forwarding.” Then, in the switch (3), the port (1) is set in “Blocking,” and the port (2) is set in “Root.”

Herein, when the port (2) of the switch (3) is paid attention to, for example, the port status of the port (2) is set in “Root.” Then, upon detecting the port status (“Root”) of the port (2) with reference to the MIB information storing unit 70, the MIB analyzing unit 20 of the switch (3) gives the instruction of transmitting an SNMP request to the SNMP transmitting/receiving unit 30.

In accordance with a transmission instruction, the SNMP transmitting/receiving unit 30 generates and transmits an SNMP request packet for the switch (1) to acquire MIB information on the port status of the port (2) containing the link L3, with respect to the switch (1) as the adjacent switch related to the link L3 contained by the port (2) of the switch (3).

In the switch (1), when the SNMP transmitting/receiving unit 30 receives an SNMP request, the SNMP transmitting/receiving unit 30 takes out MIB information related to the port status of the port (2) from the MIB information storing unit 70, generates an SNMP response packet including the MIB information, and returns it to the switch (3).

In the switch (3), when the SNMP transmitting/receiving unit 30 receives an SNMP response, the SNMP transmitting/receiving unit 30 stores the MIB information contained in the SNMP response in the MIB information storing unit 70. Consequently, the port status of the port (2) of the switch (1) is stored in the MIB information storing unit 70 of the switch (3).

At this time, the SNMP transmitting/receiving unit 30 can be configured so as to notify the MIB analyzing unit 20 that the port status of the adjacent switch is stored in the MIB information storing unit 70.

The MIB analyzing unit 20 of the switch (3) reads the MIB information related to the port status of the port (2) of the self-switch (switch (3)) and the port status of the corresponding port (2) of the adjacent switch (switch (1)) from the MIB information storing unit 70, and extracts the port status of the self-switch and the port status of the adjacent switch for comparison. At this time, as shown in FIG. 2, the port status of the port (2) of the switch (3) is “Root,” and the port status of the port (2) of the switch (1) is “Forwarding.” Thus, the MIB analyzing unit 20 determines that a loop is not generated (normal state).

As shown in FIG. 2, the operation is performed in at least one port containing a link in the respective switches (0) to (3). When there is a plurality of ports P containing a link, the operation is performed on the port basis (per port).

Under the circumference described in FIG. 2, as shown in FIG. 3, the case where a failure has occurred in the switch (1) is assumed. Here, when a failure has occurred in a CPU of the switch (1) is assumed. In this case, since the CPU is not operated normally, the switch (1) cannot transmit a BPDU periodically based on the STP.

Accordingly, the status control unit 50 of the switch (3) cannot receive a BPDU from the switch (1). When such a state is maintained for a predetermined period of time, the status control unit 50 determines that a failure has occurred in the switch (1) and changes the port status of the port (2) in accordance with the previously set regulations. Herein, the status of the port (2) is changed from “Root” to “Forwarding.”

Furthermore, the switch (1) cannot return an SNMP response with respect to the SNMP request from the switch (3) due to the failure of the CPU. On the other hand, upon transmitting an SNMP request, the SNMP transmitting/receiving unit 30 of the switch (3) starts counting the monitoring timer for monitoring the arrival of the SNMP response. When the monitoring timer reaches time-out, the SNMP transmitting/receiving unit 30 stores “no response” as the MIB information representing the port status of the adjacent switch in the MIB information storing unit 70.

The MIB analyzing unit 20 of the switch (3) detects that the status of the port (2) has changed from “Root” to “Forwarding,” based on the notification from the status control unit 50 or the monitoring of the MIB information storing unit 70. Then, the MIB analyzing unit 20 refers to the MIB information storing unit 70 to check the port status of the port (2) of the self-switch (3) and the adjacent port (2). Then, the MIB analyzing unit 20 knows that the port (2) of the self-switch (3) is “Forwarding,” and the status of the adjacent port (2) is “no response.” In this case, the MIB analyzing unit 20 determines which of the failure of the link L3 and the failure of the adjacent switch (1) causes the SNMP response not to arrive.

More specifically, the MIB analyzing unit 20 determines whether or not a traffic from the adjacent port (2) flows into the port (2) of the switch (3). The switch (3) is configured so as to count the amount of a traffic flowing into the port (2) of the switch (3) through the link L3, and to store the counted amount in the MIB information storing unit 70 as a part of the MIB information. The amount of traffic is a known technique expressed as “if InOctets” in the MIB.

The MIB analyzing unit 20 detects the value of “if InOctets” twice at different times, and takes the difference thereof. At this time, when there is a difference, it is known that there is a traffic flow into the port (2). In contrast, when there is no difference, it is known that there is no traffic flow. Based on this, the MIB analyzing unit can recognize the reason why the SNMP response does not arrive.

The case where there is a traffic flow substantially means that the status of each port (2) of the switches (1) and (3) is “Forwarding.” In this case, there is a possibility that a data loop is generated. Therefore, the MIB analyzing unit 20 pretends to have detected a loop, and instructs the port blocking unit 40 to block the port (2) of the switch (3).

The port blocking unit 40 sets the port (2) in a closed state (link-down) in accordance with an instruction, and blocks the flow of a traffic from the switch (1). Thereby, a data loop is stayed.

When the status of the port (2) of the switch (3) has changed to “Forwarding,” the switch (1) changes the status of the port (2) of the switch (1) to “Root” in accordance with the change in the switch (3) if the state is normal.

In contrast, when the switch (1) has a failure, the status control unit 50 cannot change the status, and the status of the port (2) of the switch (1) may remain “Forwarding.” In this case, the MIB analyzing unit 20 of the switch (3) determines that both the status of the port (2) of the self-switch (3) and the status of the corresponding port (2) of the adjacent switch (1) are “Forwarding.” Then, the MIB analyzing unit 20 determines the presence/absence of the traffic flow, and when there is a traffic flow, instructs the port blocking unit 40 to block the port (2). Then, the port (2) is blocked and the data loop is stayed.

In the above-mentioned operation, regarding the port P whose port status is “Root” or “Blocking,” the SNMP transmitting/receiving unit 30 transmits the SNMP request to the adjacent switch periodically, and updates the MIB information on the status of the adjacent port on the MIB information storing unit 70 periodically. Then, the MIB analyzing unit 20 checks the status of the port with the shift of the status of the port of the self-switch to “Forwarding” as a trigger. In place of such an operation, the SNMP transmitting/receiving unit 30 can also notify the MIB analyzing unit 20 of the status update every time the MIB information on the status is updated, and check the status every time the MIB analyzing unit 20 receives the notification of the status update.

Furthermore, the MIB analyzing unit 20 can also be configured so as to instruct the SNMP transmitting/receiving unit 30 to transmit an SNMP request with the shift of the port status to “Forwarding” as a trigger, to receive the notification of a status update based on the instruction, and to check the status. In this case, the status can be checked with a newest status of the adjacent port.

### OPERATION EXAMPLE 2

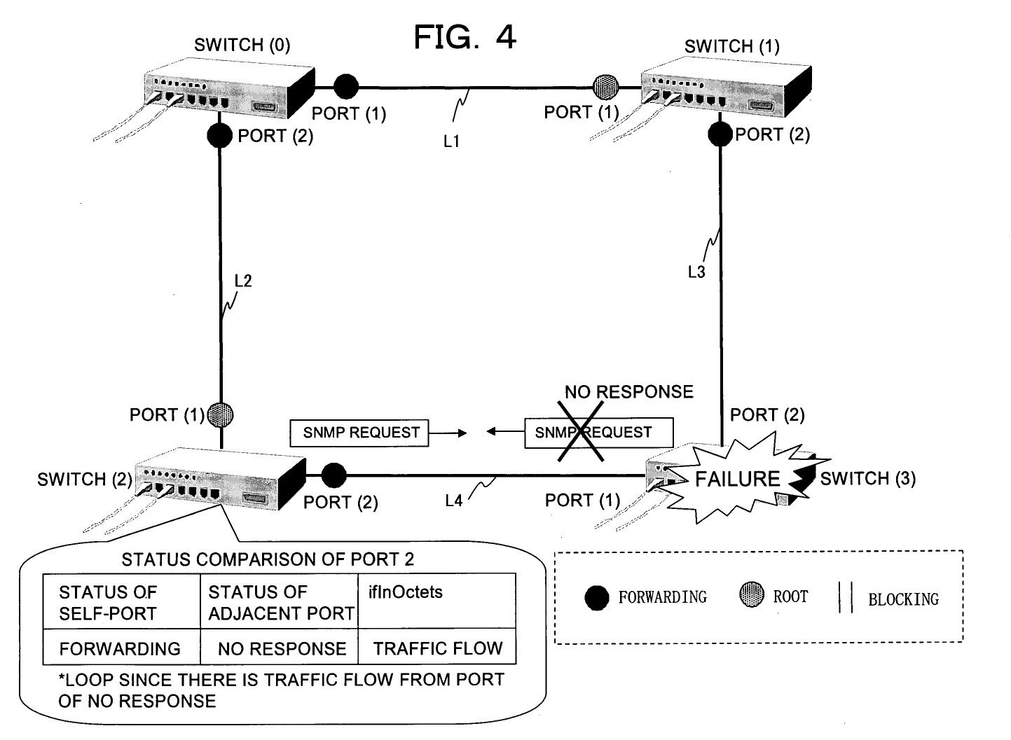

Next, Operation Example 2 will be described with reference to FIGS. 2 and 4. As shown in FIG. 2, an SNMP request is configured so as to be transmitted from a switch (switch in which a port status is “Root” or “Blocking”) on a downstream side with respect to the flow of data to an adjacent switch (switch in which a port status is “Forwarding”) on an upstream side. Furthermore, the BPDU by the STP is transmitted from the switch on the upstream side of the data to the switch on the downstream side. As shown in FIG. 2, since the port status of the port (1) of the switch (3) is “Blocking,” the SNMP request is configured so as to be transmitted with respect to the switch (2).

Herein, as shown in FIG. 4, the case is considerable in which a failure occurs in the switch (3), and the switch (3) cannot transmit an SNMP request with respect to the switch (2). In this case, the switch (3) cannot acquire the port status of the corresponding port (2) from the adjacent switch (2) by transmitting an SNMP request, so that the detection of a loop and the blocking of a port as described in Operation Example 1 cannot be performed. On the other hand, the switch (2) does not receive a BPDU from the switch (3), so that the port status of the self-switch (2) cannot be shifted, considering the port status of the switch (3). Herein, if the switch (3) is out of order in a state where data flows from the switch (3) to the switch (2) through the link L4, there is a possibility that a loop is generated.

A loop is stayed by the following configuration and operation. More specifically, the switch (3) is configured so as to transmit an SNMP request periodically with respect to the adjacent switch (2) on the upstream side. On the other hand, in the adjacent switch (2) on the upstream side, the SNMP transmitting/receiving unit 30 is configured so as to have a timer for monitoring the arrival of an SNMP request, and monitor the periodical arrival of the SNMP request from the switch (3). The timer for monitoring the SNMP request is configured so as to start counting, as a trigger, with the initial reception of an SNMP request from the adjacent switch on the downstream side by the switch, thereafter, perform a reset operation every time a subsequent SNMP request arrives, and restart counting.

In the switch (2), when the SNMP request does not arrive from the switch (3), and the timer for monitoring reaches time-out, the SNMP transmitting/receiving unit 30 is given an instruction and transmits the SNMP request to the switch (3).

Thereafter, when an SNMP response arrives and when the timer for monitoring the arrival of an SNMP response reaches time-out without the arrival of the SNMP response, the SNMP transmitting/receiving unit 30 of the switch (2) stores the MIB information on the status of the adjacent port in the MIB information storing unit 70 in the same way as in Operation Example 1, and notifies the MIB analyzing unit 20 of this (port status update of the adjacent port).

The MIB analyzing unit 20 refers to the MIB information storing unit 70, and compares the port statuses. Herein, the status of the port (2) of the self-switch (2) is “Forwarding,” and the status with respect to the corresponding port (1) of the adjacent switch (3) is “no response.” Therefore, the MIB analyzing unit 20 determines whether or not there is a traffic flow to the port (2) of the switch (2). This determination is performed by acquiring the difference of MIB information “if InOctets,” as described in Operation Example 1.

Then, in the case of determining that there is a traffic flow, the MIB analyzing unit 20 instructs the port blocking unit 40 to block (close) the port (2). Then, the port blocking unit 40 blocks (link-down) the port (2), thereby a loop is stayed.

According to Operation Example 2, the switch on the “Forwarding” side (upstream side with respect to the data flow) detects a loop, considering the port status of the adjacent switch on the “Root” or “Blocking” side (downstream side), thereby staying a loop.

### OPERATION EXAMPLE 3

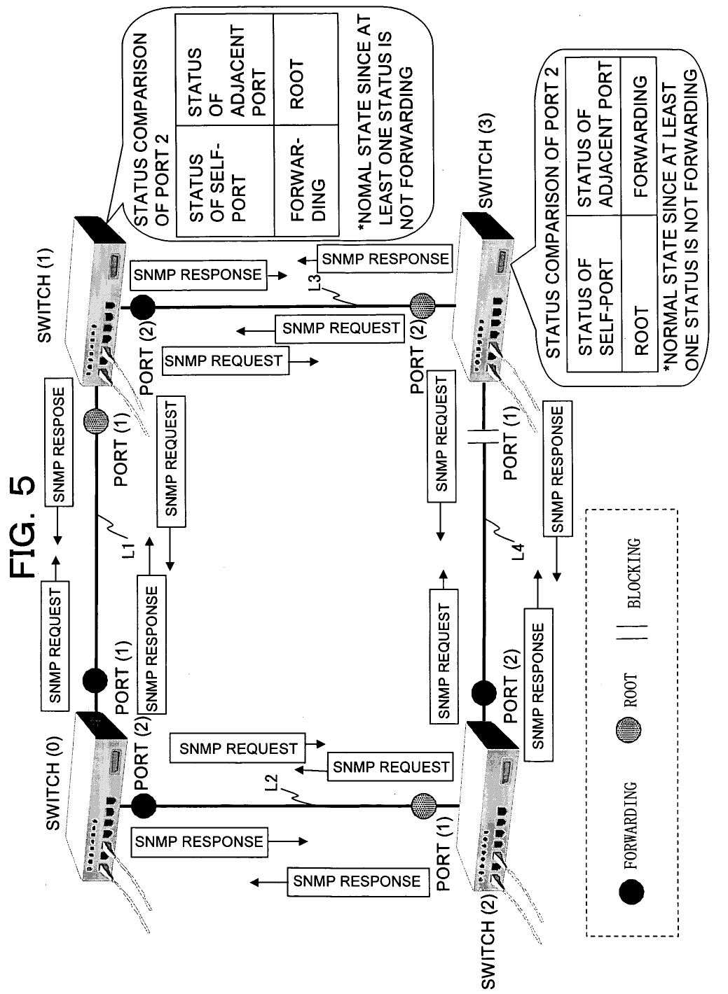

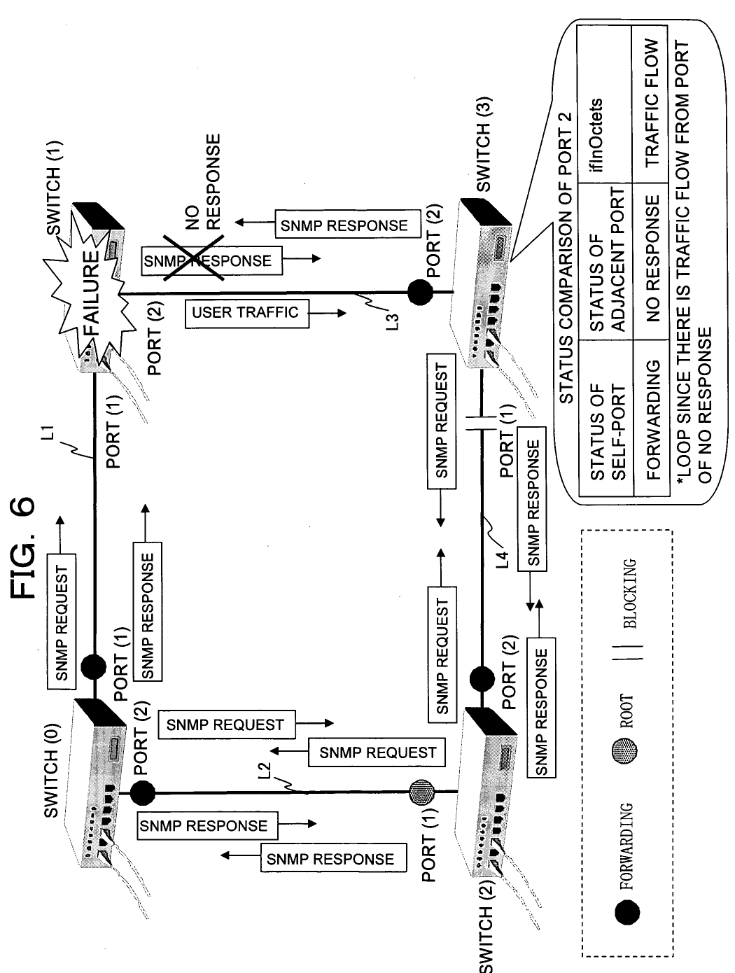

Next, Operation Example 3 in the network system shown in FIG. 2 will be described. FIGS. 5 and 6 are views illustrating Operation Example 3. In Operation Example 1, a switch positioned on a downstream side with respect to the data flow transmits an SNMP request to an adjacent switch on an upstream side. While in Operation Example 2, when an SNMP request does not arrive any more from the adjacent switch on the downstream side, the switch on the upstream side transmits an SNMP request to the adjacent switch on the downstream side.

As shown in FIG. 5, in Operation Example 3, each of switches (0) to (3) transmits periodically an SNMP request to the adjacent switch, with respect to each port P containing a link connecting to the adjacent switch, irrespective of whether or not the self-switch is upstream or downstream with respect to the data flow.

More specifically, the MIB analyzing unit 20 of the respective switches (0) to (3) instructs the SNMP transmitting/receiving unit 30 to periodically transmit an SNMP request with respect to each port P containing a link.

Then, the MIB analyzing unit 20 compares the status of the adjacent switch and the status of the corresponding port with respect to the port P, every time an SNMP request is transmitted to the adjacent switch. When the port status of the self-switch is “Forwarding,” and the port status of the adjacent switch is “Forwarding” or “no response,” the MIB analyzing unit 20 determines whether or not there is a traffic flow from the adjacent switch by the same procedure as that of Operation Example 1. If there is a traffic flow, the MIB analyzing unit 20 allows the port blocking unit 40 to block the port P of the self-switch.

FIG. 6 shows a state in which a failure occurs in the switch (1), and when an SNMP response does not arrive any more from the switch (1) to the switch (3), the switch (3) performs status comparison of ports and loop determination.

According to Operation Example 3, it is not necessary to perform a complicated procedure in which the self-switch monitors the arrival of an SNMP request from the adjacent switch, and when an SNMP request does not arrive any more, an SNMP request is transmitted from the self-switch to the adjacent switch, as described in Operation Example 2.

In performing Operation Example 3, the switch on the “Root” or “Blocking” side acquires an IP address of the adjacent switch on the “Forwarding” side to transmit an SNMP request by the same procedure as that of Operation Example 1.

On the other hand, the SNMP transmitting/receiving unit 30 of a switch on the “Forwarding” side acquires a transmission source IP address and a transmission source MAC address of an SNMP request packet transmitted from the adjacent switch on the “Root” or “Blocking” side, and registers this relationship in the MAC/IP learning table 60. Then, the SNMP transmitting/receiving unit 30 generates an SNMP request packet using the learned IP address and MAC address, and transmits it to the adjacent switch on the “Root” or “Blocking” side. The SNMP request may be transmitted almost simultaneously with the SNMP response.

[Flow of Operation Examples 1 and 2]

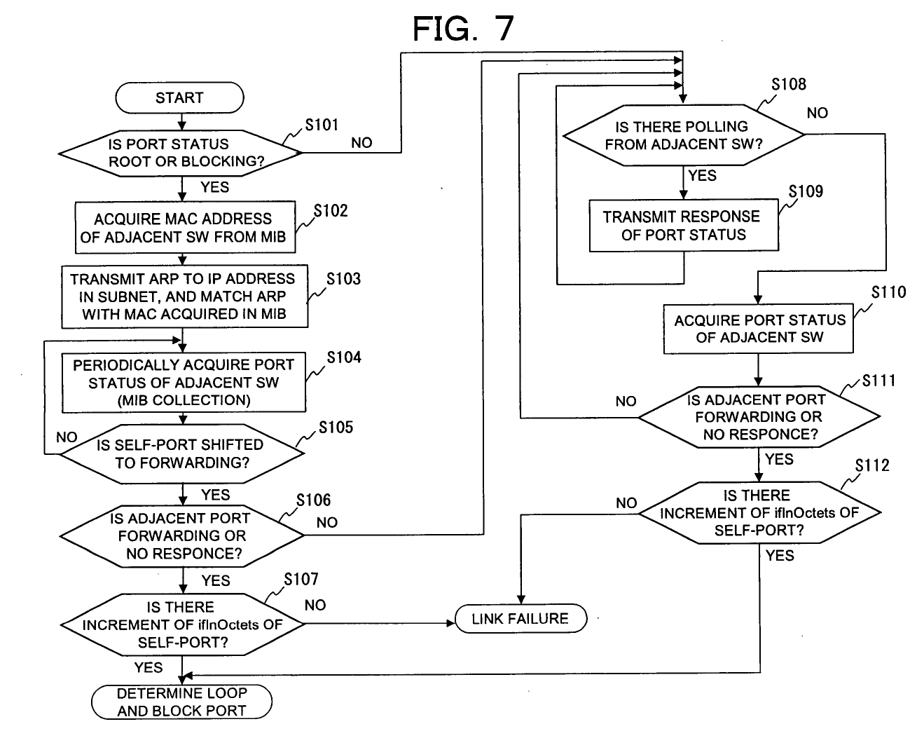

FIG. 7 is a flow chart showing an example of processing by the layer 2 switch 10 according to Operation Examples 1 and 2.

In FIG. 7, when the layer 2 switch 10 starts processing, first, the MIB analyzing unit 20 determines whether or not the status of the port P is in “Root” or “Blocking” (Step S101).

At this time, when the port status is “Root” or “Blocking” (S101; YES), the processing proceeds to Step S102, and when the port status is “Forwarding,” the processing proceeds to Step S108.

In Step S102, the MAC address of the adjacent switch is acquired from the MIB. More specifically, the MIB analyzing unit 20 gives an instruction for collecting MIB information (instruction for transmitting an SNMP request) to the SNMP transmitting/receiving unit 30. The SNMP transmitting/receiving unit 30 acquires the MAC address (included in the MIB information) of the adjacent switch in accordance with a target port P stored in the MIB information storing unit 70.

In Step S103, the SNMP transmitting/receiving unit 30 generates and transmits an ARP request packet in which a host address (excluding an IP address of the self-switch) in a subnet to which the self-switch belongs is set as an IP address of a communication partner.

Thereafter, the SNMP transmitting/receiving unit 30 receives an ARP response packet with respect to an ARP request packet, and compares the MAC address of a search destination stored in the ARP response packet with the MAC address of the adjacent switch acquired in Step S102. At this time, when the MAC addresses are matched (coincided) with each other, the IP address of the communication partner included in the ARP response packet corresponds to the IP address of the adjacent switch. The SNMP transmitting/receiving unit 30 creates and transmits an ARP request in which the IP address of the communication partner is changed (in a range of the host address of the subnet) until receiving an ARP response having the MAC address of the adjacent switch. When the SNMP transmitting/receiving unit 30 can acquire the IP address of the adjacent switch from the ARP response, the SNMP transmitting/receiving unit 30 registers the IP address and the MAC address of the adjacent switch in the MAC/IP learning table 60.

In Step S104, the port status of the adjacent switch is acquired periodically. More specifically, the SNMP transmitting/receiving unit 30 periodically generates and transmits an SNMP request for acquiring MIB information regarding the status of a correspondence port of the adjacent switch, using the MAC address and the IP address of the adjacent switch registered in the MAC/IP learning table 60.

Upon receiving an SNMP response with respect to the SNMP request from the adjacent switch, the SNMP transmitting/receiving unit 30 stores the MIB information (port status of the adjacent port) included in the SNMP response in the MIB information storing unit 70.

The MIB analyzing unit 20 confirms the port status of a target port P (self-port) stored in the MIB information storing unit 70 at a predetermined timing (e.g., in the case of being notified of the status change from the status control unit 50, or monitoring the MIB information storing unit 70), and determines whether or not the port status has shifted to “Forwarding” (Step S105). At this time, if the port status has not shifted to “Forwarding” (S105; NO), the processing returns to Step S104.

In contrast, if the port status has shifted to “Forwarding” (S105; YES), the MIB analyzing unit 20 refers to the MIB information storing unit 70, and acquires the port status of the corresponding port (adjacent port) of the adjacent switch, and determines whether or not the port status is “Forwarding” or “no response” (Step S106).

When the port status of the adjacent port is “Forwarding” or “no response” (S106; YES), the processing proceeds to Step S107, and if not so (S106; NO), the processing proceeds to Step S108.

In Step S107, the MIB analyzing unit 20 determines whether or not there is an increment of “if InOctets” of the self-port. More specifically, the MIB analyzing unit 20 searches for the information “if InOctets” stored in the MIB information storing unit twice at different times, and determines whether or not there is a difference (an increase in the count number of the traffic amount). At this time, the presence of a difference means that there is a flow of traffic from the adjacent port to the self-port.

If there is an increment (difference) (S107; YES), the MIB analyzing unit 20 determines a loop, and allows the port blocking unit 40 to block the self-port. In contrast, if there is no increment (difference) (S107; NO), it is determined that a failure (e.g., disconnection) occurs in a link connecting the self-port to the adjacent port. In this case, since a loop is not generated, port control is not particularly performed. A person performing maintenance may be notified of a link failure.

When the processing proceeds to Step S108, the status of the self-port is “Forwarding,” so that the SNMP transmitting/receiving unit 30 waits for polling (SNMP request) from the adjacent switch. Then, in the case of receiving an SNMP request (S108; YES), the SNMP transmitting/receiving unit 30 acquires MIB information on the port status with respect to the self-port from the MIB information storing unit 70, creates an SNMP response including the MIB information, and transmits it to the adjacent switch (Step S109).

In Step S108, the periodical arrival of the SNMP request is monitored by an SNMP request monitoring timer. When the SNMP request has not arrived until the monitoring timer reaches time-out, the processing proceeds to Step S110 (S108; NO).

In step S110, the SNMP transmitting/receiving unit 30 generates and transmits an SNMP request with respect to the adjacent switch. Thereafter, the SNMP transmitting/receiving unit 30 acquires the port status of the adjacent switch by receiving an SNMP response with respect to the SNMP request. The port status of the adjacent switch is stored in the MIB information storing unit 70. At this time, the MIB analyzing unit 20 is notified by the SNMP transmitting/receiving unit 30 that the port status of the adjacent switch has been updated.

When the MIB analyzing unit 20 is notified of the port status update from the SNMP transmitting/receiving unit 30, the MIB analyzing unit 20 performs the similar processing to that of Steps S106 and S107 (Steps S111, S112). Therefore, when the status of the adjacent port is “Forwarding” or “no response” (S111; YES) and there is a traffic flow (S112; YES), a loop is determined and a target port is blocked.

[Flow of Operation Example 3]

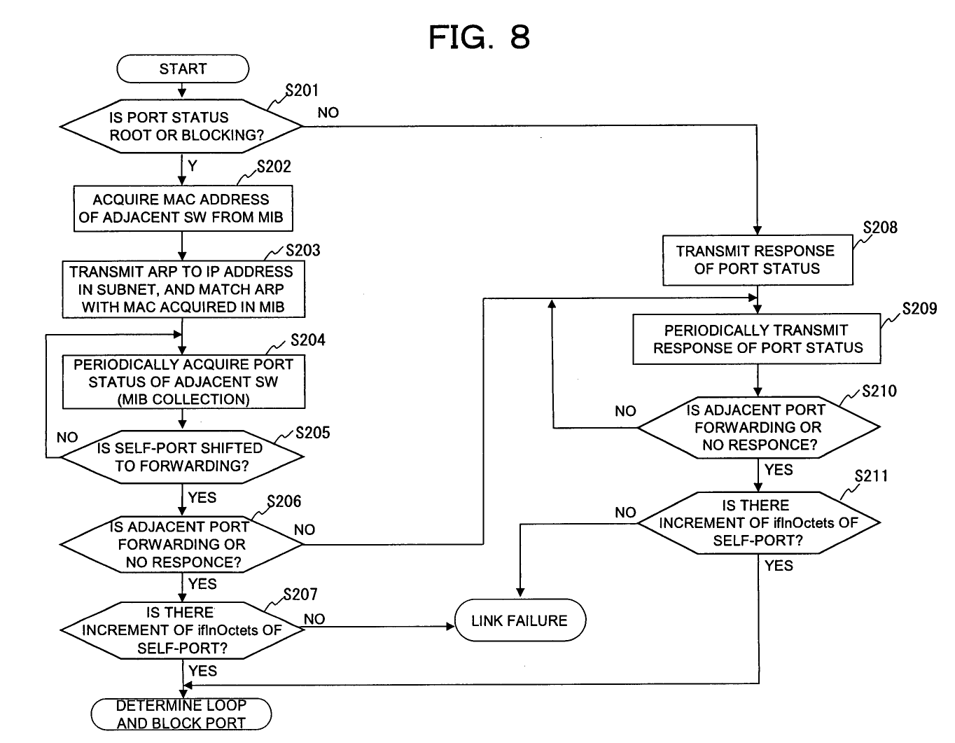

FIG. 8 is a flow chart showing an example of processing by the layer 2 switch 10 according to Operation Example 3. The processing shown in FIG. 8 is performed with respect to each port P accommodating a link.

In FIG. 8, the processing in Steps S201 to S207 is the same as that in Steps S101 to S107 shown in FIG. 7, so that the description thereof will be omitted here. In Step S208, the status of a target port of the self-switch is “Forwarding.” Therefore, the SNMP transmitting/receiving unit 30 waits for the arrival of an SNNP request from the adjacent switch on the downstream side of a flow of data (frame), and when the SNMP request arrives, the SNMP transmitting/receiving unit 30 generates and returns an SNMP response including MIB information (port status) corresponding to the SNMP request.

At this time, the SNMP transmitting/receiving unit 30 extracts an IP address of a transmission source and a MAC address of the transmission source of the SNMP request and registers them in the MAC/IP learning table 60. Thereafter, the SNMP transmitting/receiving unit 30 periodically transmits an SNMP request for acquiring the port status from the adjacent switch to the adjacent switch on the downstream side, using the MAC address and the IP address, and updates (periodically acquire) the status of the adjacent port on the MIB information storing unit 70 at any time (Step S209).

The MIB analyzing unit 20 acquires the status of the adjacent port from the MIB information storing unit 70 at a predetermined timing (periodically, every time the status is updated). Then, the processing similar to that in Steps S111 and S112 shown in FIG. 7 is performed. More specifically, when the status of the adjacent port is “Forwarding” or “no response” (S210; YES) and there is a traffic flow (S211; YES), a loop is determined, and the target port is blocked.

[Operation and Effect of the Embodiment]

According to the embodiment of the present invention, in the case where the status control of a port based on the STP is performed in the layer 2 network, when the control of the port status based on the STP does not function effectively due to the failure of the layer 2 switch, and when the statuses of the ports respectively accommodating a link connecting switches are both “Forwarding” and there is a data traffic flow from one port to the other port, a loop is determined, and the ports are blocked. This appropriately suppresses a loop of data (frame). Furthermore, the introduction of a complicated configuration such as the introduction of a TTL to a MAC frame can be avoided.

Thus, according to the present invention, when there is an inconsistency in a port status between the ports accommodating the same link (e.g., when both the ports are forwarding), or when the other port status to be compared with one port status cannot be acquired, a frame loop can determined (a loop is detected), and the ports can be blocked.

Furthermore, as described in the present embodiment, the detection precision of a loop can be enhanced by including whether or not there is a traffic input from a self-device to an adjacent device (S107, S112, S207, S211) to determination conditions of a loop. In this case, a port can be stayed from being blocked when it is not necessary to block the port (in the case of a disconnection of a link). In this sense, the determination of the presence/absence of a traffic input (S107, S112, S207, S211) is an additional constituent component of the present invention.

[Others]

The embodiment described above discloses the following invention. The constituent elements of the claimed present invention can be appropriately combined in a range not deviating from the object of the present invention. Furthermore, the present invention can also be realized as the invention of a method having the same features as those of the invention of a device described below and the invention of a program.

What is claimed is:

1. A frame forwarding device for forwarding a frame in a network of a datalink layer, comprising:
an acquisition unit acquiring a status of an adjacent port from an adjacent device having the adjacent port accommodating a link accommodated in a port of a self-device;
a determination unit determining whether or not a loop of a frame is generated based on an inconsistency between a status of the port of the self-device and the status of the adjacent port; and
a blocking unit blocking the port of the self-device when determined that the loop is generated.

2. The frame forwarding device according to claim 1, wherein the acquisition unit transmits a request packet for inquiring about the status of the adjacent port to the adjacent device, and receives a response packet with respect to the request packet, and
the determination unit acquires the status of the adjacent port included in the response packet and performs the determination.

3. The frame forwarding device according to claim 1, wherein the determination unit determines that the loop is generated when both the status of the port of the self-device and the status of the adjacent port represent forwarding of a frame, or when the status of the adjacent port to be compared with the status of the port of the self-device cannot be acquired from the adjacent device.

4. The frame forwarding device according to claim 3, wherein the determination unit further determines that the loop is generated when there is a frame input from the adjacent device to the port of the self-device.

5. The frame forwarding device according to claim 2, wherein the acquisition unit acquires an IP address of the adjacent device, using an address of a subnet to which the self-device belongs and a MAC address of the adjacent device, when the status of the port of the self-device is not a status of forwarding a frame, and generates and transmits the request packet using the IP address and the MAC address of the adjacent device.

6. The frame forwarding device according to claim 5, wherein the acquisition unit transmits to the subnet an ARP request packet in which a host address belonging to the subnet is set as an IP address of a communication partner, receives an APR response packet with respect to the ARP request packet, checks a MAC address of a search destination included in the ARP response packet with a MAC address of the adjacent device, and when both the MAC addresses are matched with each other, specifies the IP address of the communication partner included in the ARP response packet as the IP address of the adjacent device.

7. The frame forwarding device according to claim 2, wherein the determination unit compares the status of the port of the self-device with the status of the adjacent port every time the response packet is received.

8. The frame forwarding device according to claim 2, wherein the determination unit compares the status of the port of the self-device with the status of the adjacent port when the status of the port of the self-device is shifted from a certain status to a predetermined status.

9. The frame forwarding device according to claim 2, wherein the acquisition unit periodically receives the request packet from the adjacent device, returns a response packet including a status of a corresponding port with respect to each request packet, and when the request packet does not arrive any more, transmits the request packet to the adjacent device.

10. The frame forwarding device according to claim 2, wherein the acquisition unit periodically receives the request packet from the adjacent device, returns a response packet including a status of a corresponding port with respect to each request packet, and in a case of transmitting the response packet, generates and transmits a request packet for inquiring about the status of the corresponding adjacent port from the adjacent device.

11. A method for staying a loop of a frame, comprising:
acquiring a status of an adjacent port from an adjacent device having the adjacent port accommodating a link accommodated in a port of a self-device in a network in which a frame of a datalink layer is forwarded;
determining whether or not a frame loop is generated based on an inconsistency between a status of the port of the self-device and the status of the adjacent port; and
blocking the port of the self-device when determined that the loop is generated.

12. A program for controlling a computer to execute the steps of:
acquiring a status of an adjacent port from an adjacent device having the adjacent port accommodating a link accommodated in a port of a self-device in a network in which a frame of a datalink layer is forwarded;
determining whether or not a frame loop is generated based on an inconsistency between a status of the port of the self-device and the status of the adjacent port; and
blocking the port of the self-device when determined that the loop is generated.
